(19) United States
(12) Patent Application Publication
(10) Pub. No.: US 2014/0175685 A1
(43) Pub. Date: Jun. 26, 2014

(54) Method for Making Silicone Hydrogel Contact Lenses

(71) Applicant: Novartis AG, Basel (CH)

(72) Inventors: Jinyu Huang, Suwanee, GA (US); Daqing Wu, Suwanee, GA (US); Uwe Haken, Norcross, GA (US); Horngyih Huang, New Taipei City (TW); Manivakkam J. Shankernarayanan, Alpharetta, GA (US)

(73) Assignee: Novartis AG, Basel (CH)

(21) Appl. No.: 14/108,426

(22) Filed: Dec. 17, 2013

Related U.S. Application Data
(60) Provisional application No. 61/739,908, filed on Dec. 20, 2012.

(51) Int. Cl. B29D 11/00

(52) U.S. Cl. CPC B29D 11/00192; B29D 11/00038; B29D 11/00134
USPC 264/2.6

(57) ABSTRACT

The instant invention pertains to a method and a fluid polymerizable composition for producing contact lenses with improved lens quality and with increased product yield. The method of the invention involves adding a water soluble and/or water dispersible quaternary ammonium cationic group containing silicone surfactant into a fluid polymerizable composition including a lens-forming material in an amount sufficient to reduce an averaged mold separation force by at least about 30% in comparison with that without the water soluble and/or water dispersible quaternary ammonium cationic group containing silicone surfactant.

This application claims the benefit under 35 USC §119 (e) of U.S. provisional application No. 61/739,908 filed Dec. 20, 2012, incorporated by reference in its entirety.

The present invention is related to a method for making contact lenses. In particular, the present invention is related to a method for facilitating mold separation and lens removal from a mold in a cast-molding process of contact lenses using a water soluble/dispersible quaternary ammonium cationic group containing silicone surfactant as mold releasing agents, thereby enhancing the quality and yield of produced contact lenses.

### BACKGROUND

Contact lenses can be manufactured economically in a mass production manner by a conventional cast-molding process involving disposable molds (e.g., PCT published patent application No. WO/87/04390, EP-A 0 367 513, U.S. Pat. No. 5,894,002, all of which are herein incorporated by reference in their entireties) or by an improved cast-molding process involving reusable molds and curing under a spatial limitation of actinic radiation (U.S. Pat. Nos. 5,508,317, 5,583,163, 5,789,464 and 5,849,810). A critical step in the production of lenses using molds is mold opening and lens releasing from the mold without damaging the lens. Subsequent to the completion of the contact lens molding process, the polymerized lens tends to strongly adhere to the mold. During mold opening and removing the contact lenses from the mold, cracks, flaws and/or tears may occur in the lenses or in the worst case the contact lenses even break totally. Contact lenses having such defects have to be discarded and lower the overall production yield.

Several methods have been developed or proposed. One method for releasing lenses is to hydrate the lens, namely, a lens-in-mold assembly after mold separation is placed in a hydration tank filled with water. Often hydration alone does not release the lenses from the molds. The lenses must then be gently removed from molds by hand. Such hand-assisted lens removal increases the likelihood of lens damage. U.S. Pat. No. 5,264,161 discloses an improved method for releasing a lens from a mold, in which surfactants are added to the hydration bath to facilitate the release of lenses from molds. However, the utilization of surfactants in a hydration bath does not provide a more effortless mold separation. Lens damage incurred during mold separation may not be minimized by hydrating lenses.

Another method of lens release is to incorporate surfactants as internal mold releasing agents into molds themselves as illustrated by U.S. Pat. No. 4,159,292. Incorporation of internal mold releasing agents in molds can decrease adhesion between lenses and molds. However, when a mold is used repeatedly, surfactants as internal mold releasing agent can be exhausted by exudation.

A further method of lens release is to apply external mold releasing agents (e.g., surfactants) in the form of a film or coating onto to the molding surfaces of a mold (e.g., those disclosed in U.S. Pat. Nos. 4,929,707 and 5,542,978). When external mold releasing agents are used, a portion of the agents used for treating the molding surfaces of the mold can migrate to the surface and interior of the polymerized lens.

A still further method of lens release is to incorporate internal mold releasing agents into a lens-forming composition for making contact lenses. The internal mold releasing agent can be a surfactant (U.S. Pat. Nos. 4,534,916, 4,929,707, 4,946,923, 5,013,496, 5,021,503, 5,126,388, 5,594,088, 5,753,730) or a non-polymerizable polymer (U.S. Pat. No. 6,849,210). By incorporation of an internal mold releasing agent in a lens-forming composition (or lens formulation), the adhesion between molds and lenses may be reduced, a relatively smaller force may be required to separate mold, and lenses may be removed from molds with less effort. A portion of the internal mold releasing agent need migrate to the surface of the polymerized lens in order to be effective to reduce the adhesion between molds and lenses. A great effort has been made to develop technologies for cast molding of hydrogel contact lenses with high precision, fidelity and reproducibility and at low cost. One of such manufacturing technologies is the so-called Lightstream Technology™ (Alcon) involving a lens-forming composition being substantially free of monomers and comprising a substantially purified prepolymer with ethylenically-unsaturated groups, reusable molds, and curing under a spatial limitation of actinic radiation (e.g., UV), as described in U.S. Pat. Nos. 5,508,317, 5,583,463, 5,789,464, and 5,849,810.

However, there are some practical limitations which hinder realization of all of the great potentials of such technology in the production of silicone hydrogel contact lenses. For example, when a silicone-containing prepolymer disclosed in commonly-owned U.S. Pat. Nos. 7,091,283, 7,268,189 and 7,238,750 is used to prepare a silicone hydrogel lens formulation, an organic solvent is generally required to solubilize the prepolymer. When such lens formulation is used to produce silicone hydrogel according to the Lightstream Technology™, the cured lens in the mold after UV crosslinking is still swollen in the organic solvent before the solvent exchange to water. Such lens may not be able to survive the mold opening and de-molding process, because the cured lens is in the swollen state in the organic solvent and has an inadequate stiffness and toughness (e.g., too low). As such, the production yield may be low and the production cost could be higher due to low production yield derived from the lens defects created during mold opening and de-molding process. However, conventional release mold agents are not effective to reduce lens defects created during mold opening and de-molding process in manufacturing contact lenses from silicone-containing prepolymers. The defects created during mold separation can be a big issue in manufacturing contact lenses with silicone-containing prepolymer according to the Lightstream Technology™.

Therefore, there is a need for a method for using a new mold releasing agent for molding contact lenses. There is also a need for a method for using a new mold releasing agent for molding silicone hydrogel contact lenses. There is a further need for a process for cast-molding contact lenses with an enhanced quality and enhanced yield achieved by reducing mold separation force and lens-mold adhesion through using a new mold releasing agent for molding silicone-containing prepolymer contact lenses with Lightstream Technology™.

In recent years, soft silicone hydrogel contact lenses become more and more popular because of their high oxygen permeability and comfort. However, most commercially available silicone hydrogel contact lenses are produced according to a conventional cast molding technique involving use of disposable plastic molds and a mixture of monomers in the presence or absence of macromers. However, disposable plastic molds inherently have unavoidable dimensional variations, because, during injection-molding of plastic molds, fluctuations in the dimensions of molds can occur as a result of fluctuations in the production process (temperatures, pressures, material properties), and also because the resultant molds may undergo non-uniformly shrinking after the injection molding. These dimensional changes in the mold may lead to fluctuations in the parameters of contact lenses to be produced (peak refractive index, diameter, basic curve, central thickness etc.) and to a low fidelity in duplicating complex lens design.

Such disadvantages encountered in a conventional cast-molding technique can be overcome by using the so-called Lightstream Technology™ (Alcon), as illustrated in U.S. Pat. Nos. 5,508,317, 5,789,464, 5,849,810, and 6,800,225, which are incorporated by reference in their entireties. The Lightstream Technology™ involves (1) a lens-forming composition which is typically a solution of one or more substantially purified prepolymer with ethylenically unsaturated groups and which generally is substantially free of monomers and crosslinking agents with a small molecular weight, (2) reusable molds produced in high precision, (3) curing under a spatial limitation of actinic radiation (e.g., UV); and washing and reusing the reusable molds. Lenses produced according to the Lightstream Technology™ can have high consistency and high fidelity to the original lens design, because of use of reusable, high precision molds. In addition, contact lenses with high quality can be produced at relatively lower cost due to the short curing time and a high production yield.

But, the Lightstream Technology™ has been difficult to be applied to make silicone hydrogel contact lenses. One potential issue in the manufacture of silicone hydrogel contact lenses based on Lightstream Technology™ is that the silicone-containing components of a lens formulation has a strong mold adhesion to reusable molds (such as, Quartz/Glass molds) The strong adhesion may be likely caused by the interaction between hydrophilic groups on the lens surface and the hydrophilic mold surface such as hydrogen bonding. The silicone hydrogel contact lenses lens may not be able to survive the mold opening and de-molding process, because the strong adhesion between lens material and mold surface. As such, the production yield may be low and the production cost could be higher due to low production yield derived from the lens defects created during mold opening and de-molding process. However, conventional release mold agents are not effective to reduce lens defects created during mold opening and de-molding process in manufacturing contact lenses from silicone-containing prepolymers. The defects created during mold separation can be a big issue in manufacturing contact lenses with silicone-containing prepolymer according to the Lightstream Technology™.

Therefore, there is a need for a method for using a new mold releasing agent for molding contact lenses. There is also a need for a method for using a new mold releasing agent for molding silicone hydrogel contact lenses. There is a further need for a process for cast-molding contact lenses with an enhanced quality and enhanced yield achieved by reducing mold separation force and lens-mold adhesion through using a new mold releasing agent for molding silicone-containing prepolymer contact lenses with Lightstream Technology™.

### SUMMARY OF THE INVENTION

The invention, in one aspect, provides a method for producing silicone hydrogel contact lenses, comprising the steps of:

(1) providing a mold for making soft contact lenses, wherein the mold has a first mold half with a first molding surface defining an anterior surface of a contact lens and a second mold half with a second molding surface defining a posterior surface of the contact lens, wherein said first and second mold halves are configured to receive each other such that a cavity is formed between said first and second molding surfaces;
(2) introduce a fluid polymerizable composition comprising at least one actinically-crosslinkable water processable siloxane-containing prepolymer and at least one water soluble and/or dispersible quaternary ammonium cationic group containing silicone surfactant into the cavity, (3) curing the fluid polymerizable composition in the mold to form a silicone hydrogel contact lens, wherein the formed silicone hydrogel contact lens comprises the anterior surface defined by the first molding surface, the opposite posterior surface defined by the second molding surface,
(4) separating the mold, wherein the water soluble/dispersible silicone surfactant is present in an amount sufficient to reduce an averaged mold separation force by at least about 30% in comparison with that without the water soluble/dispersible quaternary ammonium cationic group containing silicone surfactant.

The invention, in another aspect, provides a method for producing a contact lens, comprising: the steps of:

(1) providing a mold for making soft contact lenses, wherein the mold has a first mold half with a first molding surface defining an anterior surface of a contact lens and a second mold half with a second molding surface defining a posterior surface of the contact lens, wherein said first and second mold halves are configured to receive each other such that a cavity is formed between said first and second molding surfaces;
(2) applying to at least a part of a surface of the mold a layer of water soluble and/or dispersible quaternary ammonium cationic group containing silicone surfactant,
(3) at least partially drying said layer,
(4) introduce a fluid polymerizable composition into the cavity, wherein the fluid polymerizable composition comprises at least one actinically-crosslinkable water processable siloxane-containing prepolymer,
(5) curing the fluid polymerizable composition in the mold to form a silicone hydrogel contact lens, wherein the formed silicone hydrogel contact lens comprises the anterior surface defined by the first molding surface, the opposite posterior surface defined by the second molding surface; and
(6) separating the mold, wherein the water soluble/dispersible surfactant is present is present in an amount sufficient to reduce an averaged mold separation force by at least about 30% in comparison with that without the water soluble and/or dispersible silicone surfactant.

### DETAILED DESCRIPTION OF EMBODIMENTS OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

An “ophthalmic device”, as used herein, refers to a contact lens (hard or soft), an intraocular lens, a corneal onlay, other ophthalmic devices (e.g., stents, glaucoma shunt, or the like) used on or about the eye or ocular vicinity.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. A “silicone hydrogel contact lens” refers to a contact lens comprising a silicone hydrogel material.

A “hydrogel” or “hydrogel material” refers to a crosslinked polymeric material which can absorb at least 10 percent by weight of water when it is fully hydrated.

A “silicone hydrogel” refers to a silicone-containing hydrogel obtained by copolymerization of a polymerizable composition comprising at least one silicone-containing vinylic monomer or crosslinker or at least one actinically-crosslinkable silicone-containing prepolymer.

“Hydrophilic,” as used herein, describes a material or portion thereof that will more readily associate with water than with lipids.

A “monomer” refers to a compound that can be polymerized chemically, actinically or thermally.

A “vinylic monomer”, as used herein, refers to a monomer that has one sole ethylenically unsaturated group and can be polymerized actinically or thermally.

The term “olefinically unsaturated group” or “ethylenically unsaturated group” is employed herein in a broad sense and is intended to encompass any groups containing at least one >C═C< group. Exemplary ethylenically unsaturated groups include without limitation (meth) acryloyl

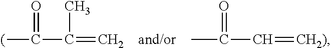

allyl, vinyl, styrenyl, or other C═C containing groups.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV irradiation, ionizing radiation (e.g. gamma ray or X-ray irradiation), microwave irradiation, and the like. Thermal curing or actinic curing methods are well-known to a person skilled in the art.

The term “(meth) acrylamide” refers to methacrylamide and/or acrylamide.

The term “(meth)acrylate” refers to methacrylate and/or acrylate.

A “hydrophilic vinylic monomer”, as used herein, refers to a vinylic monomer which as a homopolymer typically yields a polymer that is water-soluble or can absorb at least 10 percent by weight water.

A “hydrophobic vinylic monomer”, as used herein, refers to a vinylic monomer which as a homopolymer typically yields a polymer that is insoluble in water and can absorb less than 10 percent by weight water.

A “prepolymer” refers to a polymer that contains ethylenically unsaturated groups and can be polymerized actinically or thermally to form a polymer having a molecular weight larger than the starting prepolymer.

A “polymer” means a material formed by polymerizing/crosslinking one or more vinylic monomers, crosslinkers and/or prepolymers.

“Molecular weight” of a polymeric material (including monomeric or macromeric materials), as used herein, refers to the number-average molecular weight unless otherwise specifically noted or unless testing conditions indicate otherwise.

A “crosslinker” refers to a compound having at least two ethylenically-unsaturated groups. A “crosslinking agent” refers to a compound which belongs to a subclass of crosslinkers and comprises at least two ethylenically unsaturated groups and has a molecular weight of 700 Daltons or less.

A “polysiloxane” refers to a compound containing one sole polysiloxane segment.

A “chain-extended polysiloxane” refers to a compound containing at least two polysiloxane segments separated by a linkage.

A “polysiloxane crosslinker” refers to a compound having at least two ethylenically unsaturated groups and one sole polysiloxane segment.

A “chain-extended polysiloxane crosslinker” refers to a linear polysiloxane compound which comprises at least two ethylenically unsaturated groups and at least two polysiloxane segments separated by a linkage.

A “polysiloxane vinylic monomer” refers to a vinylic monomer containing one sole ethylenically unsaturated group and one sole polysiloxane segment.

A “chain-extended polysiloxane vinylic monomer” refers to a compound which comprises one sole ethylenically unsaturated group and at least two polysiloxane segments separated by a linkage.

The term “fluid” as used herein indicates that a material is capable of flowing like a liquid.

A free radical initiator can be either a photoinitiator or a thermal initiator. A “photoinitiator” refers to a chemical that initiates free radical crosslinking/polymerizing reaction by the use of light. Suitable photoinitiators include, without limitation, benzoin methyl ether, diethoxyacetophenone, a benzoylphosphine oxide, 1-hydroxycyclohexyl phenyl ketone, Darocure® types of photoinitiators, and Irgacure® types of photoinitiators, preferably Darocure® 1173, and Irgacure® 2959. Examples of benzoylphosphine oxide initiators include 2,4,6-trimethylbenzoyldiphenylophosphine oxide (TPO); bis-(2,6-dichlorobenzoyl)-4-N-propylphenylphosphine oxide; and bis-(2,6-dichlorobenzoyl)-4-N-butylphenylphosphine oxide. Reactive photoinitiators which can be incorporated, for example, into a prepolymer or can be used as a special monomer are also suitable. Examples of reactive photoinitiators are those disclosed in EP 632 329, herein incorporated by reference in its entirety. The polymerization can then be triggered off by actinic radiation, for example light, in particular UV light of a suitable wavelength. The spectral requirements can be controlled accordingly, if appropriate, by addition of suitable photosensitizers.

A “thermal initiator” refers to a chemical that initiates radical crosslinking/polymerizing reaction by the use of heat energy. Examples of suitable thermal initiators include, but are not limited to, 2,2′-azobis (2,4-dimethylpentanenitrile), 2,2′-azobis (2-methylpropanenitrile), 2,2′-azobis (2-methylbutanenitrile), peroxides such as benzoyl peroxide, and the like. Preferably, the thermal initiator is 2,2′-azobis (isobutyronitrile) (AIBN).

A “spatial limitation of actinic radiation” refers to an act or process in which energy radiation in the form of rays is directed by, for example, a mask or screen or combinations thereof, to impinge, in a spatially restricted manner, onto an area having a well defined peripheral boundary, as illustrated in U.S. Pat. Nos. 6,800,225, 6,627,124, 7,384,590 and 7,387,759 (all of which are incorporated by reference in their entireties).

A “hydrophilic surface” in reference to a silicone hydrogel material or a contact lens means that the silicone hydrogel material or the contact lens has a surface hydrophilicity characterized by having an averaged water contact angle of about 90 degrees or less, preferably about 80 degrees or less, more preferably about 70 degrees or less, even more preferably about 60 degrees or less.

The term “soluble” in reference to a compound or material means that the compound or material can be dissolved in a solvent to an extent sufficient to form a solution having a concentration of at least about 1% by weight at room temperature (about 22° C. to about 28° C.).

The term “water solubility and/or dispersity” in reference to a compound or material means the concentration (weight percentage) of the compound or material dissolved and/or dispersed in water at room temperature (about 22° C. to about 28° C.) to form a transparent aqueous solution or a slightly hazy aqueous solution having a light transmissibility of 85% or greater in the range between 400 to 700 nm.

The term “water-processable” in reference to a silicone-containing polymerizable material means that the silicone-containing polymerizable component can be dissolved at room temperature (about 22° C. to about 28° C.) in an ophthalmically compatible solvent to form a lens-forming composition (or formulation) having a light transmissibility of 85% or greater in the range between 400 to 700 nm.

The term “ophthalmically compatible solvent” refers to a solvent which may be in intimate contact with the ocular environment for an extended period of time without significantly damaging the ocular environment and without significant user discomfort. “Ocular environment”, as used herein, refers to ocular fluids (e.g., tear fluid) and ocular tissue (e.g., the cornea) which may come into intimate contact with a contact lens used for vision correction, drug delivery, wound healing, eye color modification, or other ophthalmic applications. Preferred examples of ophthalmically compatible solvents include without limitation water, 1,2-propylene glycol, a polyethyleneglycol having a molecular weight of about 400 Daltons or less, and combinations thereof.

A “percentage of reduction in mold separation force” or “R_{MSF} % T” is calculated by the following formula

$${R}_{MSF} \% = \frac{{MSF}_{o} - {MSF}_{releasing agent}}{{MSF}_{o}} \times 100$$

in which MSF_{releasing agent} is the averaged mold separation force measured with molds with a coat of a releasing agent or a mold releasing agent is added into lens forming material prior to lens curing; MSFₒ is the averaged mold separation force measured with molds without coat of releasing agent or without adding a mold releasing agent into lens forming material prior to lens curing as control, when being used in cast molding of ophthalmic lenses (preferably contact lenses) from a fluid lens-forming composition.

The term “mold separation force” as used herein refers to a force required for separating a mold after casting molding a contact lens from a lens-forming composition in the mold. Mold separation force is proportional to adhesion between a mold and a lens cast-molded therein.

An “averaged mold separation force” refers to a value obtained by averaging at least 3, preferably at least 5, more preferably at least 10, independent measurements of mold separation force (i.e., 10 testing samples).

In general, the invention is directed to a method for reducing adhesion between a mold (or mold half) and a contact lens cast-molded in the mold. The method of the invention relies on a water soluble and/or water dispersible silicone surfactant containing quaternary ammonium cationic group as an internal mold releasing agent in a lens-forming formulation (composition). The method of the invention can also rely on water soluble and/or water dispersible silicone surfactant containing quaternary ammonium cationic group as an external mold releasing agent to coat the water soluble and/or water dispersible silicone surfactant containing quaternary ammonium cationic group solution onto a mold surface. A water soluble and/or water dispersible silicone surfactant containing quaternary ammonium cationic group of the invention is selected to reduce an averaged mold separation force by at least about 30% in comparison with that without the water soluble and/or water dispersible silicone surfactant containing quaternary ammonium cationic group.

The invention is partly based on the discovery that a water soluble and/or water dispersible silicone surfactant containing quaternary ammonium cationic group can be used as an efficient mold releasing agent in a lens-forming composition including an actinically crosslinkable water processable siloxane containing prepolymer. The invention is also based on the discovery that a water soluble and/or water dispersible silicone surfactant containing quaternary ammonium cationic group can be used as an efficient mold releasing agent in a lens-forming composition including an actinically crosslinkable, water processable siloxane containing prepolymer as a lens-forming material, when a reusable mold is used to make the lenses, wherein the reusable mold is made from materials such as glass, PMMA, quartz, TOPAS® or CaF₂. This advantage to reduce adhesion force of silicone hydrogel contact lenses to that reusable mold enhances quality and improves production yield.

Although the inventors do not wish to be bound by any particular theory, it is believed that reduction of mold separation force by the presence of a mold releasing agent can be explained as follows: The strong mold adhesion of silicone hydrogel contact lens to the Quartz/Glass molds is likely caused by the interaction between hydrophilic group(s) on the lens surface and the hydrophilic mold surface such as hydrogen bonding. Quartz/glass molds are partially negatively charged. The water soluble and/or dispersible quaternary ammonium cationic group containing silicone surfactant (such as: Silquat® Di-10 and Silquat® D2) contains positively charged quaternary ammonium groups. When the water soluble/dispersible quaternary ammonium cationic group containing silicone surfactant is present in a silicone hydrogel contact lens formulation with a sufficient concentration, a layer of water soluble/dispersible quaternary ammonium cationic group containing silicone surfactant can form on the interface due to the strong electrostatic interaction between those two opposite charges. As a result, this layer of the water soluble/dispersible quaternary ammonium cationic group containing silicone surfactant prevents hydrophilic group(s) on the surface of silicone hydrogel contact lens from adhering to the molds, reducing the adhesion force.
The invention provides a method for producing silicone hydrogel contact lenses, comprising the steps of:
   (1) providing a mold for making soft contact lenses, wherein the mold has a first mold half with a first molding surface defining an anterior surface of a contact lens and a second mold half with a second molding surface defining a posterior surface of the contact lens, wherein said first and second mold halves are configured to receive each other such that a cavity is formed between said first and second molding surfaces;
   (2) introduce a fluid polymerizable composition comprising at least one actinically-crosslinkable water processable siloxane-containing prepolymer and at least one water soluble and/or dispersible quaternary ammonium cationic group containing silicone surfactant into the cavity, (3) curing the fluid polymerizable composition in the mold to form a silicone hydrogel contact lens, wherein the formed silicone hydrogel contact lens comprises the anterior surface defined by the first molding surface, the opposite posterior surface defined by the second molding surface,
   (4) separating the mold, wherein the water soluble/dispersible silicone surfactant is present in an amount sufficient to reduce an averaged mold separation force by at least about 30% in comparison with that without the water soluble/dispersible quaternary ammonium cationic group containing silicone surfactant.

Any suitable actinically-crosslinkable water-processable siloxane-containing prepolymer can be used in the invention. Examples of actinically-crosslinkable siloxane-containing prepolymer are described in a commonly-owned copending US patent application publication No. 2012-0088861 filed Oct. 5, 2011 (entitled “WATER-PROCESSABLE SILICONE-CONTAINING PREPOLYMERS AND USES THEREOF”, herein incorporated in reference in its entirety.

In accordance with the invention, a fluid polymerizable composition comprising at least one actinically-crosslinkable water processable siloxane-containing prepolymer and at least one water soluble and/or dispersible quaternary ammonium cationic group containing silicone surfactant. The actinically-crosslinkable siloxane-containing prepolymer comprises: (1) siloxane-containing monomeric units and/or polysiloxane-containing crosslinking units, wherein the siloxane-containing monomeric units are derived from one or more siloxane-containing vinylic monomers each having at least one hydrophilic moiety selected from the group consisting of a hydrophilic polymeric chain with a molecular weight of up to about 10,000 Daltons (preferably about 7500 Dalton or less, more preferably about 5000 Daltons or less), a hydroxyl group, an amide linkage, a urethane linkage (or carbamate linkage), a diurethane linkage, an oligo-ethyleneoxide linkage (i.e., composed about 2 to about 12 ethyleneoxide units), a 2-hydroxy-substituted propyleneoxide linkage, and combinations thereof, wherein the polysiloxane-containing crosslinking units are derived from at least one hydrophilized polysiloxane crosslinker and/or chain-extended hydrophilized polysiloxane crosslinker each having one or more pendant hydrophilic polymer chains; (2) hydrophilic monomeric units derived from one or more hydrophilic vinylic monomers; (3) from about 0.05% to about 5%, preferably from about 0.1% to about 4%, more preferably from about 0.5 to about 3% by weight of polymerizable units each having a pendant or terminal, ethylenically-unsaturated group and free of any polysiloxane segment; and (4) optionally hydrophobic units derived from at least one hydrophobic vinylic monomer free of silicone, wherein the prepolymer comprises from about 20% to about 50%, preferably from about 25% to about 45%, more preferably from 28% to about 40%, by weight of silicone relative to the total weight of the prepolymer and has a high water solubility or dispersibility of at least about 5%, preferably at least about 10%, more preferably at least about 20% by weight in water, wherein the prepolymer is capable of being actinically crosslinked, in the absence of one or more vinylic monomers, to form a silicone hydrogel contact lens having a water content of from about 20% to about 75% (preferably from about 25% to about 70%, more preferably from about 30% to about 65%) by weight when fully hydrated, an oxygen permeability (Dk) of at least about 40 barrers (preferably at least about 50 barrers, more preferably at least about 60 barrers, and even more preferably at least about 70 barrers), and optionally (but preferably) a hydrophilic surface characterized by an average water contact angle of about 90 degrees or less (preferably about 80 degrees or less, more preferably 70 degrees or less, even more preferably about 60 degrees or less) without post-molding surface treatment.

Such prepolymer can be obtained by first polymerizing a polymerizable composition including (a) at least one siloxane-containing vinylic monomer having at least one hydrophilic moiety and/or at least one hydrophilized polysiloxane and/or chain extended polysiloxane crosslinker having one or more pendant hydrophilic polymer chains, (b) at least one hydrophilic vinylic monomer, (c) an ethylenically functionalizing vinylic monomer having a first reactive functional group (other than ethylenically unsaturated group), (d) a chain transfer agent with or without a second reactive functional group (other than thiol group), and (e) optionally a hydrophobic vinylic monomer, to form a water-processable intermediary copolymer and then by ethylenically functionalizing the intermediary copolymer with an ethylenically functionalizing vinylic monomer having a third reactive functional group capable of reacting with the first and/or second reactive functional group to form a linkage in a coupling reaction in the presence or absence of a coupling agent to form the prepolymer, wherein the first, second and third reactive functional groups independent of one another are selected from the group consisting of amino group, hydroxyl group, carboxyl group, acid halide group, azlactone group, isocyanate group, epoxy group, aziridine group, and combination thereof. The general procedures for preparing amphiphilic prepolymers are disclosed in commonly-owned U.S. Pat. Nos. 6,039,913, 6,043,328, 7,091,283, 7,268,189 and 7,238,750, 7,521,519; commonly-owned US patent application publication Nos. US 2008-0015315 A1, US 2008-0143958 A1, US 2008-0143003 A1, US 2008-0234457 A1, US 2008-0231798 A1, and commonly-owned U.S. patent application Ser. Nos. 12/313,546, 12/616,166 and 12/616,169; all of which are incorporated herein by references in their entireties.

In accordance with the invention, any siloxane-containing vinylic monomers can be used in the preparation of a water-processable prepolymer of the invention so long as they have at least one hydrophilic moiety selected from the group consisting of a hydrophilic polymer chain with a molecular weight of up to about 10,000 Daltons or less (preferably about 7500 daltons or less, more preferably about 5000 daltons or less, even more preferably about 2500 Daltons or less, most preferably about 1000 Daltons or less), a hydroxyl group, an amide linkage, a urethane linkage (or carbamate linkage), a diurethane linkage, an oligo-ethyleneoxide linkage (i.e., composed about 2 to 12 ethyleneoxide units), a 2-hydroxy-substituted propyleneoxide linkage, and combinations thereof.

Exemplary siloxane-containing vinylic monomers are described in U.S. Pat. Nos. 4,711,943, 5,070,215, 5,998,498, 7,071,274, 7,112,641 (herein incorporated by reference in their entireties). The preparation of such monomers is described in those patents.

In accordance with the invention, any hydrophilized polysiloxane or chain-extended polysiloxane crosslinkers can be used in the preparation of a water-processable prepolymer of the invention so long as they comprise at least one pendant hydrophilic polymer chain.

The term “hydrophilic polymer chain” as used in this patent application refers to a pendant and/or terminal polymer chain unless otherwise specifically noted, which can be a linear or 3-arm (or Y-shape) hydrophilic polymer chain that comprises at least about 60%, preferably at least about 70%, more preferably at least about 80%, even more preferably at least about 90%) by weight of one or more hydrophilic monomeric units selected from the group consisting of ethyleneoxides (—CH₂CH₂O—), (meth)acrylamide units, C₁-C₃ alkyl (meth)acrylamide units, di-(C₁-C₃ alkyl)(meth)acrylamide units, N-vinylpyrrole units, N-vinyl-2-pyrrolidone units, 2-vinyloxazoline units, 4-vinylpyridine units, mono-C₁-C₄ alkoxy, mono-(meth)acryloyl terminated polyethyleneglycol units having a molecular weight of 2000 Daltons or less, di(C₁-C₃ alkyl amino)(C₂-C₄ alkyl)(meth)acrylate units, N—C₁-C₄ alkyl-3-methylene-2-pyrrolidone units, N—C₁-C₄ alkyl-5-methylene-2-pyrrolidone units, N-vinyl C₁-C₆ alkylamide units, N-vinyl-N—C₁-C₆ alkyl amide units, and combinations thereof. Preferably, the linear or 3-arm (or Y-shape) hydrophilic polymer chain comprises bulky vinylic monomeric units (any one of those described above)

In accordance with the invention, any suitable hydrophilic vinylic monomers can be used in preparation of a prepolymer of the invention. Suitable hydrophilic vinylic monomers are, without this being an exhaustive list, hydroxyl-substituted C₁-C₆ alkyl (meth)acrylates, hydroxyl-substituted C₁-C₆ alkyl vinyl ethers, C₁ to C₆ alkyl (meth)acrylamide, di-(C₁-C₆ alkyl)(meth)acrylamide, N-vinylpyrrole, N-vinyl-2-pyrrolidone, 2-vinyloxazoline, 2-vinyl-4,4′-dialkyloxazolin-5-one, 2- and 4-vinylpyridine, olefinically unsaturated carboxylic acids having a total of 3 to 6 carbon atoms, amino-substituted C₁-C₆ alkyl- (where the term “amino” also includes quaternary ammonium), mono(C₁-C₆ alkyl amino)(C₁-C₆ alkyl) and di(C₁-C₆ alkyl amino)(C₁-C₆ alkyl)(meth)acrylates, allyl alcohol, N-vinyl C₁-C₆ alkylamide, N-vinyl-N—C₁-C₆ alkyl amide, and combinations thereof.

Any suitable hydrophobic vinylic monomers can be used in the preparation of a water-processable prepolymer of the invention. Examples of preferred hydrophobic vinylic monomers include methyl (meth)acrylate, ethyl (meth)acrylate, propyl (meth)acrylate, isopropyl (meth)acrylate, butyl (meth)acrylate, sec-butyl (meth)acrylate, isobutyl (meth)acrylate, t-butyl (meth)acrylate, cyclohexylacrylate, 2-ethylhexylacrylate, vinyl acetate, vinyl propionate, vinyl butyrate, vinyl valerate, styrene, chloroprene, vinyl chloride, vinylidene chloride, acrylonitrile, 1-butene, butadiene, methacrylonitrile, vinyl toluene, vinyl ethyl ether, perfluorohexylethyl-thio-carbonyl-aminoethyl-methacrylate, isobornyl methacrylate, trifluoroethyl methacrylate, hexafluoro-isopropyl methacrylate, hexafluorobutyl methacrylate, a silicone-containing vinylic monomer, and mixtures thereof.

An “ethylenically functionalizing vinylic monomer” throughout of this patent application refers to a vinylic monomer having one reactive functional group capable of participating in a coupling (or crosslinking) reaction known to a person skilled in the art. Any vinylic monomer having a hydroxy, amino, carboxyl, epoxy, aziridine, acid-chloride, isocyanate group, which is coreactive with isocyanate, amine, hydroxyl, carboxy, or epoxy groups of a polysiloxane in the absence or presence of a coupling agent (those described above), can be used in ethylenically functionalizing the polysiloxane.

The polymerizable composition for preparing an intermediary copolymer can be a melt, a solventless liquid in which all necessary components are blended together, or a solution in which all necessary component is dissolved in an inert solvent (i.e., should not interfere with the reaction between the reactants in the mixture), such as water, an organic solvent, or mixture thereof, as known to a person skilled in the art.

In accordance with the invention, a water-processable prepolymer comprises from about 20% to about 50%, preferably from about 25% to about 45%, more preferably from about 28% to about 40%, by weight of silicone relative to the total weight of the prepolymer. As used in this patent application, the term “silicone” refers to a tris (organic group)-substituted silyl group and/or a di (organic group)-substituted siloxane unit, wherein the organic group can be alkyl, tris (methyl) siloxyl, and/or alkene diradical. The weight percentage of silicone in a prepolymer can be calculated based on the percentages of all of the siloxane-containing vinylic monomer(s) and hydrophilized polysiloxane and/or chain-extended polysiloxane crosslinker(s) relative to the total weight of all of polymerizable components and based on the weight percentages of silicone relative to the molecular weight (or average molecular weight) of the siloxane-containing vinylic monomer(s) and hydrophilized polysiloxane and/or chain-extended polysiloxane crosslinker(s).

The fluid polymerizable compositions of the present invention comprise at least a water soluble/dispersible quaternary ammonium cationic group containing silicone surfactant. In some non-limiting embodiments, the water soluble/dispersible quaternary ammonium cationic group containing silicone surfactant is at least partially water soluble. As used herein with respect to the water soluble/dispersible quaternary ammonium cationic group containing silicone surfactant, “water soluble” means that the a water soluble/dispersible quaternary ammonium cationic group containing silicone surfactant is capable of being at least partially or fully dissolved in water at ambient temperature (about 25° C.). The solubility of a component of the compositions of the present invention, for example solubility of the water soluble/dispersible quaternary ammonium cationic group containing silicone surfactant, can be determined by adding 1.0 weight percent of the component to water at 25° C. and mixing thoroughly (about 5 minutes) with a magnetic stirrer. The mixture is permitted to stand for 24 hours and the clarity and separation of components of the mixture is assessed by visual observation. A clear, generally haze-free solution is “water soluble”, a hazy/turbid solution is “water dispersible” or “partially water soluble”, and a mixture that separates into layers or has noticeable solid particulates is “water insoluble”. The evaluation can be performed in the presence of up to 1.0 weight percent of a cosolvent, such as isopropyl alcohol, to aid in solubilization of the component. Alternatively, the same procedure can be performed using an organic solvent, such as toluene, instead of water to evaluate the component for lipophile solubility.

Examples of preferred quaternary ammonium cationic group containing silicone surfactant include without limitation C₈-C₁₈ alkyl-trimethylammonium salts, silicone containing polyquats described in U.S. Pat. No. 4,185,087 (herein incorporated by reference in its entirety), and combination thereof. Preferably, a cationic surfactant is a silicone-containing polyquat of formula (I)

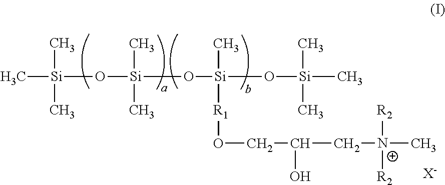

in which R₁ is a C₁-C₈ alkylene divalent radical (preferably propylene divalent radical), R₂ is C₁-C₈ alkyl radical (preferably C₁-C₄ alkyl radical, more preferably methyl or ethyl radical), X⁻ is a halogen ion (Cl⁻, Br⁻, or I⁻), a is an integer of from 10 to 50, b is an integer of from 2 to 8. A silicone-containing polyquat of formula (I) can be prepared according to the procedures described in U.S. Pat. No. 4,185,087. The more preferred quaternary ammonium cationic group containing silicone surfactant of formula (I), R₁ is propylene divalent radical and R₂ is methyl or ethyl and for example, Silquat® D2 is commercially available from Siltech Corporation, Toronto, Canada.
Examples of preferred quaternary ammonium cationic group containing silicone surfactant include a cationic surfactant represented by formula (II):

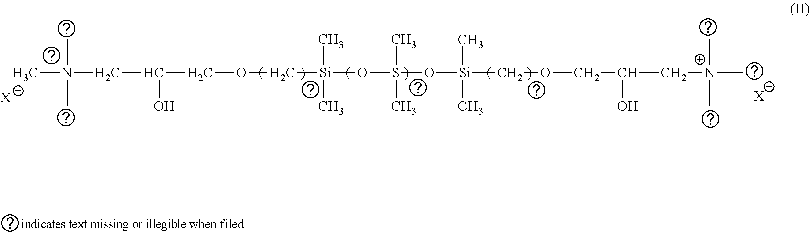

in which R1, R2, R3 and R4, independently of each other, is a C1-C8 alkyl radical (preferably C1-C4 alkyl radical, more preferably methyl or ethyl radical), X— is a halogen ion (Cl—, Br—, or I—), n is an integer of from 10 to 50. For example, Silquat® Di-10 is commercially available from Siltech Corporation, Toronto, Canada.

The a water soluble and/or water dispersible quaternary ammonium cationic group containing silicone surfactant is present in the fluid polymerizable composition in an amount sufficient to reduce an averaged mold separation force by at least about 30%, preferably by at least about 40%, more preferably by at least about 50%, in comparison with that without the a water soluble or water dispersible quaternary ammonium cationic group containing silicone surfactant (i.e., compared with the averaged mold separation force obtained when replacing the fluid polymerizable composition with a control composition). The control composition comprises all components except the water soluble or water dispersible quaternary ammonium cationic group containing silicone surfactant of the fluid polymerizable composition (i.e., free of a water soluble or water dispersible quaternary ammonium cationic group containing silicone surfactant).

In accordance with the invention, the water soluble or water dispersible quaternary ammonium cationic group containing silicone surfactant can be used as an internal mold release agent. In this embodiment, the a water soluble or water dispersible quaternary ammonium cationic group containing silicone surfactant can present in the fluid polymerizable composition in an amount of up to 150% by weight, preferably up to 15% by weight, more preferably from 1% to 10% by weight, even more preferably from 2% to 10% by weight, most preferably from 3% to 7% by weight each based on the entire weight of the fluid polymerizable composition.

The invention, in another aspect, provides a method for producing a contact lens, comprising: the steps of:

(1) providing a mold for making soft contact lenses, wherein the mold has a first mold half with a first molding surface defining an anterior surface of a contact lens and a second mold half with a second molding surface defining a posterior surface of the contact lens, wherein said first and second mold halves are configured to receive each other such that a cavity is formed between said first and second molding surfaces;
(2) applying to at least a part of a surface of the mold a layer of water soluble and/ordispersible quaternary ammonium cationic group containing silicone surfactant,
(3) at least partially drying said layer,
(4) introduce a fluid polymerizable composition into the cavity, wherein the fluid polymerizable composition comprises at least one actinically-crosslinkable water processable siloxane-containing prepolymer,
(5) curing the fluid polymerizable composition in the mold to form a silicone hydrogel contact lens, wherein the formed silicone hydrogel contact lens comprises the anterior surface defined by the first molding surface, the opposite posterior surface defined by the second molding surface; and
(6) separating the mold, wherein the water soluble/dispersible surfactant is present is present in an amount sufficient to reduce an averaged mold separation force by at least about 30% in comparison with that without the water soluble and/or dispersible silicone surfactant.

In accordance with the invention, the water soluble and/or water dispersible quaternary ammonium cationic group containing silicone surfactant can also be used as an external mold release agent. In this embodiment, the water soluble or water dispersible quaternary ammonium cationic group containing silicone surfactant can be dissolved in any suitable solvent known to a person skilled in the art before being applied to the mold surface. Then, the mold surface can be at least partially dried. Examples of suitable solvents are water, alcohols, such as lower alkanols (e.g., ethanol, methanol or isopropanol), carboxylic acid amides (e.g., dimethylformamide), dipolar aprotic solvents, such as dimethyl sulfoxide or methyl ethyl ketone, ketones (e.g., acetone or cyclohexanone), hydrocarbons (e.g., toluene, ethers, THF, dimethoxyethane or dioxane), and halogenated hydrocarbons (e.g., trichloroethane), and mixtures of suitable solvents (e.g., mixtures of water with an alcohol, a water/ethanol or a water/methanol mixture). The solution comprises, based on the entire weight of the solution, 0.01% to 50%, preferably 0.1 to 10%, and more preferably 1 to 20% and in particular 5 to 15% of the water soluble and/or water dispersible quaternary ammonium cationic group containing silicone surfactant. The solution of the water soluble and/or water dispersible quaternary ammonium cationic group containing silicone surfactant may be applied to the mold surface by any known method, for example, by spraying, swabbing, dipping or stamping such that the surface is evenly coated therewith. Spraying using a spray nozzle is preferred. The time required for steps applying the water soluble or water dispersible quaternary ammonium cationic group containing silicone surfactant to the mold surface and at least partially drying is not critical as such. However, it has to be pointed out that even with very short cycle times, for example, less than 10 seconds, used in today's contact lens production, particularly favorable results may be been obtained.

Lens molds for making contact lenses are well known to a person skilled in the art and, for example, are employed in cast molding or spin casting. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material.

Methods of manufacturing mold sections for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. No. 4,444,711 to Schad; U.S. Pat. No. 4,460,534 to Boehm et al.; U.S. Pat. No. 5,843,346 to Morrill; and U.S. Pat. No. 5,894,002 to Boneberger et al., which are also incorporated herein by reference.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, N.J.), or the like can be used. Preferable mold materials are those allow UV light transmission and could be used to make reusable molds, such as quartz, glass, CaF2, PMMA and sapphire.

A person skilled in the art will know well how to actinically or thermally crosslink and/or polymerize (i.e., cure) the lens-forming material within the lens-forming cavity to form the contact lens.

In a preferred embodiment, where a fluid polymerizable composition is a solution, solvent-free liquid, or melt of one or more prepolymers optionally in presence of other components, reusable molds are used and the lens-forming material is cured actinically under a spatial limitation of actinic radiation to form a contact lens. Examples of preferred reusable molds are those disclosed in U.S. patent application Ser. No. 08/274,942 filed Jul. 14, 1994, Ser. No. 10/732,566 filed Dec. 10, 2003, Ser. No. 10/721,913 filed Nov. 25, 2003, and U.S. Pat. No. 6,627,124, which are incorporated by reference in their entireties.

In this case, a fluid polymerizable composition is put into a mold consisting of two mold halves, the two mold halves not touching each other but having a thin gap of annular design arranged between them. The gap is connected to the mold cavity, so that excess lens material can flow away into the gap. Instead of polypropylene molds that can be used only once, it is possible for reusable quartz, glass, sapphire molds to be used, since, following the production of a lens, these molds can be cleaned rapidly and effectively off the uncrosslinked prepolymer and other residues, using water or a suitable solvent, and can be dried with air. Reusable molds can also be made of Topas® COC grade 8007-S10 (clear amorphous copolymer of ethylene and norbornene) from Ticona GmbH of Frankfurt, Germany and Summit, N.J. Because of the reusability of the mold halves, a relatively high outlay can be expended at the time of their production in order to obtain molds of extremely high precision and reproducibility. Since the mold halves do not touch each other in the region of the lens to be produced, i.e. the cavity or actual mold faces, damage as a result of contact is ruled out. This ensures a high service life of the molds, which, in particular, also ensures high reproducibility of the contact lenses to be produced.

The two opposite surfaces (anterior surface and posterior surface) of a contact lens are defined by the two molding surfaces while the edge is defined by the spatial limitation of actinic irradiation rather than by means of mold walls. Typically, only the lens-forming material within a region bound by the two molding surfaces and the projection of the well defined peripheral boundary of the spatial limitation is crosslinked whereas any lens-forming material outside of and immediately around the peripheral boundary of the spatial limitation is not crosslinked, and thereby the edge of the contact lens should be smooth and precise duplication of the dimension and geometry of the spatial limitation of actinic radiation. Such method of making contact lenses are described in U.S. patent application Ser. No. 08/274,942 filed Jul. 14, 1994, Ser. No. 10/732,566 filed Dec. 10, 2003, Ser. No. 10/721,913 filed Nov. 25, 2003, and U.S. Pat. No. 6,627,124, which are incorporated by reference in their entireties.

A spatial limitation of actinic radiation (or the spatial restriction of energy impingement) can be effected by masking for a mold that is at least partially impermeable to the particular form of energy used, as illustrated in U.S. patent application Ser. No. 08/274,942 filed Jul. 14, 1994 and U.S. Pat. No. 6,627,124 (herein incorporated by reference in their entireties) or by a mold that is highly permeable, at least at one side, to the energy form causing the crosslinking and that has mold parts being impermeable or of poor permeability to the energy, as illustrated in U.S. patent application Ser. No. 10/732,566 filed Dec. 10, 2003, Ser. No. 10/721,913 filed Nov. 25, 2003 and U.S. Pat. No. 6,627,124 (herein incorporated by reference in their entireties). The energy used for the crosslinking is radiation energy, especially UV radiation, gamma radiation, electron radiation or thermal radiation, the radiation energy preferably being in the form of a substantially parallel beam in order on the one hand to achieve good restriction and on the other hand efficient use of the energy.

A mold can be opened according to any suitable methods known to a person skilled in the art. A mold is separated into a male mold half and a female mold half, with the molded lens adhered to one of the two mold halves. After opening the mold, the lens is dislodged (removed) from its adhering mold half and can be subjected to one or more of the following known processes, extraction, surface treatment (e.g., plasma coating, LbL coating, corona treatment, etc.), hydration, equilibration, packaging, and sterilization (e.g., autoclave).

Preferred examples of prepolymers, the water soluble and/or water dispersible quaternary ammonium cationic group containing silicone surfactant, fluid polymerizable compositions, molds, and the amounts of the water soluble or water dispersible quaternary ammonium cationic group containing silicone surfactant are those described above.

The previous disclosure will enable one having ordinary skill in the art to practice the invention. In order to better enable the reader to understand specific embodiments and the advantages thereof, reference to the following examples is suggested.

### Synthesis of macromer

### Example 1

### Synthesis of α,α′-Dihydroxy Terminated Poly (N,N-Dimethyl Acrylamide) (PDMA-(OH)₂)

This PDMA was prepared by radical polymerization of DMA using 3-mercapto-1,2-propanediol as the chain transfer reagent. In this experiment, DMA (44.410 g, 448 mmol), AIBN (0.184 g), 3-mercapto-1,2-propanediol (6.687 g, 61.8 mmol), ethyl acetate (10.2 g) and toluene (102.6 g) were introduced into a 500 mL Jacketed Reactor equipped with a condenser, overhead stirrer, and gas dispersion tube. The solution was purged with N₂ gas for 30 min at room temperature, before it was heated to 58° C. After 50 minutes, the reaction was stopped by stopping the heating, purging the solution with air, and immediately siphoning the solution to a flask in an ice-bath. GC samples were taken at the beginning and end of the reaction for monomer conversion. The PDMA solution was then concentrated to about 70 g using rota-yap under vacuum at 30° C. water bath before being precipitated into 800 mL of hexanes with stirring. After 10 minutes, the supernatant was decanted. 100-150 mL of THF was added to the beaker to dissolve the polymer. After two more cycles of concentration-precipitation-dissolution, the solution was solvent-exchanged to toluene. The PDMA toluene solution was transferred into an amber bottle. The final weight of the solution was adjusted to 90 g by adding toluene. Then 10 g of ethyl acetate was added the solution. Several different batches of those PDMA solutions were combined to make a big batch of PDMA stock solution. The solid content of the PDMA solution was measured by a gravimetric method.

### Example 2

### Preparation of a Stock Solution of (PDMA-(OH)₂) and HO-PDMS-OH

HO-PDMS-OH (MW of 955 g/mol), obtained from ShinEstu, was dried under vacuum at 60° C. overnight. 75.35 g of this pre-dried PDMS was added to 240.74 g of above prepared PDMA solution with solid content of 32.33%. The OH content of this mixture was 1.33 meq/g determined by OH titration.

### Example 3

### Synthesis of PDMA Grafted PDMS (NCO/OH=1.10)

54.13 g of the above prepared PDMA/PDMS stock solution and 27.5 g of toluene were added to a pre-dried 200 mL Schlenk flask. 26-28 g of solvent from the flask was stripped off under vacuum at 80° C. After the flask was backfilled with N₂, 27 g of dry toluene was added using the airtight syringe. The solution was vacuum stripped again to remove 26-28 g of solvent, followed by backfill with N₂. Dry toluene was added into the reactor to make the final weight of contents of about 47.88 g. The flask was then put in an oil bath at 40° C. 0.3 g of sample was removed for Karl Fischer titration. The required amount of HMDI, calculated based on the molar ratio of NCO to OH of 1.10 HMDI, was added to the reactions solution with the gas-tight syringe, followed by the addition of 5.693 g of dry ethyl acetate. 3 drops of catalyst (DBTDL) were added with a second, clean & dry syringe. The solution was mixed for 3 hours before the flask was removed out of the oil bath and cooled to room temperature. The required amount of HEAA, 1.4 times the excess mole of NCO to OH, was then added with additional 3 drops of catalyst. The reaction continues overnight.

After reaction, the above reaction solution was concentrated to 30 g using rota-yap at 30° C. It was then diluted with 400-700 mL of 1-propanol and filtered through 1 um glass microfiber filter paper. The solvent exchange from 1-propanol to water was achieved via azeotropic distillation via rota-yap at 30° C. The solution with concentration of around 5% was then subject to ultra-filtration using 3 k cut-off membrane cassette. 50 L de-ionized water was used for this ultra-filtration. The collected filtrate was freeze-dried.

### Example 4

### Preparation of Stock Solution of (PDMA-(OH)₂) and HO-PDMS-OH

HO-PDMS-OH (MW of 955 g/mol) was dried under vacuum at 60° C. overnight. 86.563 g of this PDMS was added to 203.533 g of above prepared PDMA solution with solid content of 45.15%. The OH content of this mixture was 1.45 meq/g determined by OH titration.

### Example 5

### Synthesis of PDMA Grafted PDMS (NCO/OH=1.12)

47.845 g of stock solution from Exp. 4 and 27.5 g of toluene were added to a pre-dried 200 mL Schlenk flask. 26-28 g of solvent from the flask was stripped off under vacuum at 80° C. After the flask was backfilled with N₂, 27 g of dry toluene was added using the airtight syringe. The solution was vacuum stripped again to remove 26-28 g of solvent, followed by backfill with N₂. The flask was then put on an oil bath at 40° C. Dry toluene was added into the reactor to make the final weight of contents of about 52.988 g. 0.3 g of sample was removed for Karl Fischer titration. The required amount of HMDI, calculated based on the molar ratio of NCO to OH of 1.12 HMDI, was added to the reactions solution with the gas-tight syringe, followed by the addition of 5.88 g of dry ethyl acetate. 3 drops of catalyst (DBTDL) were added with a second, clean & dry syringe. The solution was mixed for 3 hours before the flask was removed out of the oil bath and cooled to room temperature. The required amount of HEAA, 1.4 times the excess mole of NCO to OH, was then added with additional 3 drops of catalyst. The reaction continues overnight.

After reaction, the above reaction solution was concentrated to 30 g using rota-yap at 30° C. It was then diluted with 400-700 mL of 1-propanol and filtered through 1 um glass microfiber filter paper. The solvent exchange from 1-propanol to water was achieved via azeotropic distillation via rota-yap at 30° C. The solution with concentration of around 5% was then subject to ultra-filtration using 3 k cut-off membrane cassette. 50 L of de-ionized water was used for this ultra-filtration. The collected filtrate was freeze-dried.

### Formulation Preparation

### Example 6

### Control Formulations

1) Preparation of 58% macromer/DPGME stock solution: Appropriate amounts of macromer and DPGME were weighed into a speed mixing cup. The sample was mixed in a speed mixer at 2000-4000 RPM for 5 minutes. Multiple mixing cycles were used until the solution was homogeneous.
2) Preparation of 6% Irgacure 2959/DPGME stock solution: Appropriate amounts of Irgacure 2959 and DPGME were weighed in an amber jar. The solution was then homogenized by stirring for 2 minutes.
3) Preparation of final formulation (5 g): 4.74 g of macromere stock solution and 0.25 g of Irgacure 2959 solution were weighed into a speed mixing cup. The formulation was mixed in a speed mixer at 2000-4000 RPM for 5 minutes. Multiple mixing cycles might be used. The final formulation had 55% macromere, 0.3% Irgacure 2959, and 43.7% DPGME.

### Example 7

### Formulation with Mold Release Agent (MRA)

a) Appropriate amounts of the macromer from example 3, Irgacure 2959 solution, MRA, DPGME were weighed into a speed mixing cup. The formulation was mixed in a speed mixer at 2000-4000 RPM with 5 minute cycle time until the solution was homogeneous. For all formulations, Irgacure 2959 concentration was set at 0.3% and the macromer concentrations was either 50% or 55%. MRA concentrations varied as shown in Table 1.
b) The same formulation process as example 7 (a) was used except that the macromer from example 5 was used for the formulation
Molds: Re-usable Lightstream quartz/glass molds
Evaluation: Mold separation force (MSF) is the force which is needed to open a mold pair after the contact lens is manufactured. The MSF is measured by a tensile testing machine (Zwick 2. 5). In the test set-up one mold half is rigidly fixed, the other mold half is fixed in a double cardanic mounting to enable force-free alignment. The molds were opened at a speed of 50 mm/min.
Lens fabrication: UV crosslinking is performed by irradiation of the molds, filled with the appropriate formulation, by an UV lightsource (6 mW/cm²). Molds were opened at the speed ranging from 1 mm/min to 50 min/min. After the lens was loosened with water, the lens was placed into blisters with 0.65 mL PBS saline. The CLOQA was carried out.
CLOQA: Contact lens optical quality assessment is based on the Foucault knife-edge test. This test is modified to evaluate the contact lenses deformation, Schlieren, and other optical properties.

### Materials:

### DMA: N,N-Dimethylacrylamide SAFC

### AIBN: 2′2 Azobisisobutyronitrile Aldrich

CTA: 1-thiolglycerol Aldrich
EA: Ethyl acetate Fisher
HO-PDMS-OH: α,ω-dihydroxy poly(dimethyl siloxane (MW of 955 g/mol): ShinEstu ShinEstu
HMDI: 1,6-hexyl diisocyanate Aldrich

### THF: Tetrahydrofuran Fisher

HEAA: N-hydroxyethyl acrylamide Aldrich
DBTDL: Dibutyltin dilaurate Aldrich
DPGME: Dipropylene glycol monomethyl ether Aldrich
PGOH: 1,2-propylene glycol Aldrich

### Glycerol: Aldrich

Irgacure 2959: 4-(2-hydroxyethoxy)phenyl-(2-hydroxy-2-propyl)ketone Aldrich

### Silquat D2; Silquat A0; Silube J208-412; Silsurf B608; Silsurf B 208; Silsurf C 208

Silplex, J2S; Silquat Di-10 in hexylene glycol (70%): Siltech Corporation
H₂N-PDMS-NH₂: X-22-161A (MW of 1600 g/mol) ShinEstu

### Pluronic L92; Pluronic P92; Pluronic L31: BASF

PDMA (MW of 700 g/mol): Prepared in house
(EO)₄₅-b-(BO)₁₀: Ethylene oxide/butylene oxide: Advanced Polymer Materials Inc.

### Evaluations:

Mold separation force (MSF) is the force which is needed to open a mold pair after the contact lens is manufactured. The MSF is measured by a tensile testing machine (Zwick 2.5). In the test set-up one mold half is rigidly fixed, the other mold half is fixed in a double cardanic mounting to enable force-free alignment. Relative mold opening force is the ratio of the MSF for a formulation that contains an additive to the force needed for the control formulation without additive.

TABLE 1
Mold separation force comparison of formulations with a variety of MRA

| | | | % | | MSF (N) at |
|---|---|---|---|---|---|
| Example | MRA | % MRA | Macromer | % Solvent | 50 mm/min |
| 6 | — | 0 | 55 | 45 | 187 +/− 35 |
| | — | 0 | 55 | 45 | 222 +/− 2 |
| | Hydrophilic polymer | | | | |
| N7 (a) | Kollidon VA64 | 1 | 50 | 49 | 173.4 +/− 23.6 |
| | PVP-PVAc-K28 | | | | |
| | % Providone K-3USP, PVP-40 KDa | 1 | 50 | 49 | 117.1 +/− 10.6 |
| | PVP-PVAc-45 kDa | 1 | 50 | 49 | 173.4 ± 23.6 |
| | | 5 | 50 | 45 | 148.9 ± 7.1 |
| | | 10 | 50 | 40 | 217 ± 18.9 |
| | PVP-40 kDa | 1 | 50 | 49 | 117.1 ± 10.6 |
| | | 5 | 50 | 45 | 114.5 ± 10.3 |
| | | 10 | 50 | 40 | 205.26 ± 18.1 |
| | PDMA | 5 | 50 | 45 | 186.14 ± 27.9 |
| | (MW 700) | 10 | 50 | 40 | 175.96 ± 31.0 |
| | Non-silicone based surfactant | | | | |
| | (EO)45-b-(BO)10 | 5 | 50 | 45 | 170.4 ± 55.9 |
| | (EO)45-b-(BO)10 | 10 | 50 | 40 | 120.2 ± 15.0 |
| | LPEG2000 | 5 | 50 | 45 | 182.7 ± 37.2 |
| | Pluronic L92 | 5 | 50 | 45 | 211.4 +/− 31 |
| | Pluronic P92 | 10 | 50 | 40 | 224.9 ± 4.2 |
| | Pluronic L31 | 10 | 50 | 40 | 215.3 +/− 11.5 |
| | Didecyldimethyl ammomiun chloride | 10 | 50 | 40 | 144.3 +/− 55.0 |
| | Silicone | | | | |
| | HO-PDMS-OH | 10 | 50 | 40 | 179.6 +/− 26.3 |
| | H₂N-PDMS-NH₂ (1600 g/mol) | 5 | 55 | 40 | 80.8+/45.2 |
| | Silicone based surfactant | | | | |
| | Silquat D2 | 1 | 50 | 49 | 146.8 ± 34.3 |
| | | 5 | 50 | 45 | 81.42 ± 2.7 |
| | | 5 | 50 | 45 | 81.4 +/− 22.7 |
| | | 10 | 50 | 40 | 77.8 ± 3.7 |
| | Silquat A0 | 5 | 55 | 40 | 199.8 +/− 25.7 |
| | | 10 | 50 | 40 | 128.2 +/− 40.3 |
| | Silsurf B608 | 5 | 50 | 45 | 215.2 +/− 14.0 |
| | | 10 | 50 | 40 | 192 +/− 27.9 |
| | Silplex, J2S | 5 | 50 | 45 | 193.8 +/− 30.6 |
| | | 10 | 50 | 49 | 147.9 ± 25.4 |
| | Silsurf C208 | 10 | 50 | 40 | 225.4 +/− 5.8 |
| | Silsurf B208 | 10 | 50 | 40 | 224.6 +/− 4.8 |
| | Silube J208-412 | 10 | 50 | 40 | 213.3 +/− 8.6 |
| 7 (b) | Silquat Di-10 | 10 | 50 | 40 | 40 +/− 2 |
| | | 10 | 50 | 40 | 33.5 +/− 9.8 |
| | | 10 | 55 | 35 | 33.6 +/− 3.3 |
| | | 10 | 50 | 40 | 26.5 +/− 1.9 |
| | | 2 | 55 | 43 | 169 +/− 64 |
| | | 5 | 55 | 40 | 117 +/− 7 |
| | | 10 | 55 | 35 | 37 +/− 11 |

Note:
Silquat Di-10 and Silquat D2 used for MRA are solutions in hexylene glycol (i.e. 70% is Silquat Di-10 or Silquat D2 and 30% is hexylene glycol).

What is claimed is:

1. A method for producing silicone hydrogel contact lenses, comprising the steps of:
(1) providing a mold for making soft contact lenses, wherein the mold has a first mold half with a first molding surface defining an anterior surface of a contact lens and a second mold half with a second molding surface defining a posterior surface of the contact lens, wherein said first and second mold halves are configured to receive each other such that a cavity is formed between said first and second molding surfaces;
(2) introduce a fluid polymerizable composition comprising at least one actinically-crosslinkable water processable siloxane-containing prepolymer and at least one water soluble and/or dispersible quaternary ammonium cationic group containing silicone surfactant into the cavity, (3) curing the fluid polymerizable composition in the mold to form a silicone hydrogel contact lens, wherein the formed silicone hydrogel contact lens comprises the anterior surface defined by the first molding surface, the opposite posterior surface defined by the second molding surface,
(4) separating the mold, wherein the water soluble/dispersible silicone surfactant is present in an amount sufficient to reduce an averaged mold separation force by at least about 30% in comparison with that without the water soluble/dispersible quaternary ammonium cationic group containing silicone surfactant.

2. The method of claim 1, wherein the quaternary ammonium cationic group containing silicone surfactant comprises a cationic surfactant which is represented by formula (I) 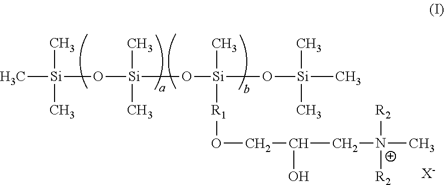
in which R₁ is a C₁-C₈ alkylene divalent radical (preferably propylene divalent radical), R₂ is C₁-C₈ alkyl radical (preferably C₁-C₄ alkyl radical, more preferably methyl or ethyl radical), X⁻ is a halogen ion (Cl⁻, Br⁻, or I⁻), a is an integer of from 10 to 50, b is an integer of from 2 to 8.

3. The method of claim 1 wherein in the cationic surfactant of formula (I), R₁ is propylene divalent radical and R₂ is methyl or ethyl.

4. The method of claim 1, wherein the mold is a reusable mold.

5. The method of claim 4, wherein the reusable mold is made of glass or quartz.

6. The method of claim 1, wherein the quaternary ammonium cationic group containing silicone surfactant comprises a cationic surfactant which is represented by formula (II) 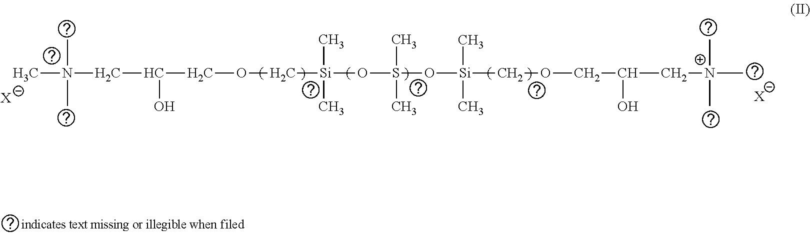
in which R₁, R₂, R₃ and R₄, independently of each other, is a C₁-C₈ alkyl radical (preferably C₁-C₄ alkyl radical, more preferably methyl or ethyl radical), X— is a halogen ion (Cl—, Br—, or I—), n is an integer of from 10 to 50.

7. The method of claim 6 wherein in the cationic surfactant of formula (II), R₁, R₂, R₃ and R₄ is methyl or ethyl.

8. A method for producing a contact lens, comprising: the steps of:
(1) providing a mold for making soft contact lenses, wherein the mold has a first mold half with a first molding surface defining an anterior surface of a contact lens and a second mold half with a second molding surface defining a posterior surface of the contact lens, wherein said first and second mold halves are configured to receive each other such that a cavity is formed between said first and second molding surfaces;
(2) applying to at least a part of a surface of the mold a layer of water soluble and/ordispersible quaternary ammonium cationic group containing silicone surfactant,
(3) at least partially drying said layer,
(4) introduce a fluid polymerizable composition into the cavity, wherein the fluid polymerizable composition comprises at least one actinically-crosslinkable water processable siloxane-containing prepolymer,
(5) curing the fluid polymerizable composition in the mold to form a silicone hydrogel contact lens, wherein the formed silicone hydrogel contact lens comprises the anterior surface defined by the first molding surface, the opposite posterior surface defined by the second molding surface; and
(6) separating the mold, wherein the water soluble/dispersible surfactant is present is present in an amount sufficient to reduce an averaged mold separation force by at least about 30% in comparison with that without the water soluble and/or dispersible silicone surfactant.

9. The method of claim 8, wherein the quaternary ammonium cationic group containing silicone surfactant comprises a cationic surfactant which is represented by formula (I) 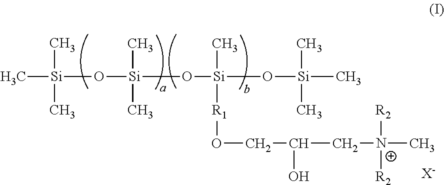
in which R₁ is a C₁-C₈ alkylene divalent radical (preferably propylene divalent radical), R₂ is C₁-C₈ alkyl radical (preferably C₁-C₄ alkyl radical, more preferably methyl or ethyl radical), X— is a halogen ion (Cl—, Br—, or I—), a is an integer of from 10 to 50, b is an integer of from 2 to 8.

10. The method of claim 9 wherein in the cationic surfactant of formula (I), R₁ is propylene divalent radical and R₂ is methyl or ethyl.

11. The method of claim 8, wherein the mold is a reusable mold.

12. The method of claim 11, wherein the reusable mold is made of glass or quartz.

13. The method of claim 8, wherein the quaternary ammonium cationic group containing silicone surfactant comprises a cationic surfactant which is represented by formula (II) 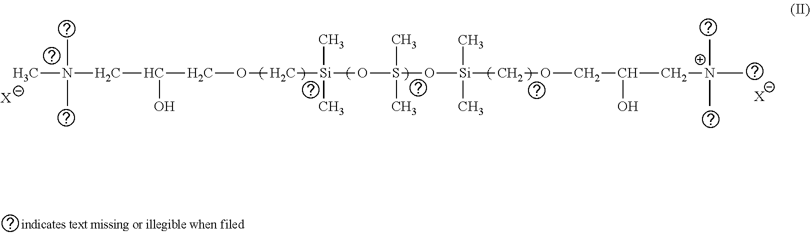
in which R₁, R₂, R₃ and R₄, independently of each other, is a C₁-C₈ alkyl radical (preferably C₁-C₄ alkyl radical, more preferably methyl or ethyl radical), X— is a halogen ion (Cl—, Br—, or I—), n is an integer of from 10 to 50.

14. The method of claim 13, wherein in the cationic surfactant of formula (II), R₁, R₂, R₃ and R₄ is methyl or ethyl.
